(19) United States
(12) Patent Application Publication
(10) Pub. No.: US 2019/0031855 A1
(43) Pub. Date: Jan. 31, 2019

(54) OPTICAL LENS MATERIAL AND OPTICAL LENS

(71) Applicant: HON HAI PRECISION INDUSTRY CO., LTD., New Taipei (TW)

(72) Inventor: HSIU-WEN CHIEN, Tu-Cheng (TW)

(21) Appl. No.: 15/675,602

(22) Filed: Aug. 11, 2017

(30) Foreign Application Priority Data
Jul. 28, 2017 (CN) 201710638309.7

(51) Int. Cl. C08K 3/22; G02B 1/04; C08K 9/02

(52) U.S. Cl. CPC C08K 3/22; G02B 1/041; C08K 2003/2241; C08K 2003/2296; C08K 9/02

(57) ABSTRACT

An optical lens material includes a cyclic block copolymer (CBC) and a reinforcing agent. The reinforcing agent is ZnO-TNTs. The ZnO-TNTs is TiO2 nanotubes incorporated with ZnO particles. The ZnO particles are adsorbed on the wall of the TiO2 nanotubes.

### CROSS-REFERENCE TO RELATED APPLICATIONS

This application claims priority to Chinese Patent Application No. 201710638309.7 filed on Jul. 28, 2017, the contents of which are incorporated by reference herein.

### FIELD

The subject matter herein generally relates to an optical lens material and optical lens.

### BACKGROUND

In recent years, the number of people with myopia has increased. Glasses are used widely to correct vision for people with myopia. Commonly, the glasses are optical lens.

The composition of the lens may include a variety of material, such as CR39, polymethyl methacrylate, Polycarbonate (PC) and cyclic block copolymers (CBCs) etc. CBCs are fully hydrogenated polymers based on styrene and conjugated dienes via anionic polymerization. The CBCs have remarkable thermal stability, excellent UV resistance ability, extra-high transparency, low water absorption, low density and superb purity. Therefore, CBCs are good material for optical lenses. However, compared to other common raw material, such as PC, an impact strength of the CBC is not good enough.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

An optical lens material of the present disclosure includes a CBC and a reinforcing agent mixed in the CBC.

The physical properties of CBC are described below: the density of the CBC is 0.93 g/cm3, a water absorption of CBC is equal or less than 0.01, a refractive index of the CBC is 1.5, a visible light transmittance of the CBC is 92%, an impact strength of the CBC is 36.

The reinforcing agent is made of a type of nanotubes incorporated with ZnO particles. The ZnO particles are adsorbed on the wall of the nanotubes. The type of nanotubes may be a TiO₂ nanotubes or other carbon nanotubes.

In the exemplary embodiment, the reinforcing agent is ZnO-TNTs. The ZnO-TNTs is TiO₂ nanotubes incorporated with ZnO particles. Thus, the ZnO-TNTs has both the high strength of the TiO₂ nanotubes and the excellent optical performance of the ZnO particles.

The ZnO-TNTs and the CBC are mixed by a melt blending. The ZnO-TNTs and CBC are reinforced in interfacial shear stress through Van der Waals interaction. So the optical lens material has an excellent impact strength. Further, the ZnO-TNTs and CBC can form ionic bond therebetween to reinforce the impact strength of the optical lens material.

A weight percentage of the ZnO-TNTs in the optical lens material is 0.1%-5.6%. The ZnO-TNTs enhances the visible light transmittance of the optical lens material to 95%-96%. The ZnO-TNTs also provides UV blocking ability and antibacterial properties for the optical lens material.

The optical lens of the present embodiment is made from the optical lens material above. The optical lens prepared by injection.

The optical lens material of the present embodiment includes a CBC and a reinforcing agent mixed in the CBC. So, the optical lens material of the present embodiment has advantages of CBC. Also, the impact strength of the optical lens material is enhanced by the reinforcing agent.

Then, the present disclosure of the optical lens material is illustrated by the following specific embodiments:

An optical lens material of the first embodiment includes a CBC and ZnO-TNTs. The ZnO-TNTs and the CBC are mixed by a melt blending. A weight percentage of the ZnO-TNTs is 0.81%. A weight percentage of the CBC is 99.19%. The optical lens of the first embodiment is made from the optical lens material of the first embodiment by injection.

The impact strength of the optical lens material of the first embodiment has a 5% improvement as compared to that of the impact strength of the CBC. The optical lens material of the first embodiment can prevent 400 nanometers UV band. The optical lens material of the first embodiment has a visible light transmittance of 92%.

An optical lens material of the second embodiment includes a CBC and ZnO-TNTs. The ZnO-TNTs and the CBC are mixed by a melt blending. A weight percentage of the ZnO-TNTs is 1.53%. A weight percentage of the CBC is 98.47%. An optical lens of the second embodiment is made from the optical lens material of the second embodiment by injection.

The impact strength of the optical lens material of the second embodiment has a 18% improvement as compared to the impact strength of the CBC. The optical lens material of the second embodiment can prevent 400 nanometers UV band. The visible light transmittance of the optical lens material of the second embodiment is 95%.

An optical lens material of the third embodiment includes a CBC and ZnO-TNTs. The ZnO-TNTs and the CBC are mixed by a melt blending. A weight percentage of the ZnO-TNTs is 2.8%. A weight percentage of the CBC is 97.2%. The optical lens of the third embodiment is made from the optical lens material of the third embodiment by injection.

The impact strength of the optical lens material of the third embodiment has a 25% improvement as compared to the impact strength of the CBC. The optical lens material of the third embodiment can prevent 400 nanometers UV band. The visible light transmittance of the optical lens material of the third embodiment is 95.2%.

An optical lens material of the fourth embodiment includes a CBC and ZnO-TNTs. The ZnO-TNTs and the CBC are mixed by a melt blending. A weight percentage of the ZnO-TNTs is 5.6%. A weight percentage of the CBC is 97.2%. The optical lens of the fourth embodiment is made from the optical lens material of the fourth embodiment by injection.

The impact strength of the optical lens material of the fourth embodiment has a 24.8% improvement as compared to the impact strength of the CBC. The optical lens material of the fourth embodiment can prevent 400 nanometers UV band. The visible light transmittance of the optical lens material of the fourth embodiment is 94%.

The embodiments shown and described above are only examples. Many details are often found in the art such as the other features of an optical lens material and optical lens. Therefore, many such details are neither shown nor described. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including the full extent established by the broad general meaning of the terms used in the claims. It will therefore be appreciated that the embodiments described above can be modified within the scope of the claims.

What is claimed is:

1. An optical lens material, comprising:
a cyclic block copolymer (CBC); and
a reinforcing agent;
wherein the reinforcing agent is made of nanotubes incorporated with ZnO particles, the ZnO particles adsorbs on the wall of the nanotubes.

2. The optical lens material of claim 1, wherein the reinforcing agent is ZnO-TNTs, the ZnO-TNTs is TiO₂ nanotubes incorporated with ZnO particles, the ZnO particles are adsorbed on the wall of the TiO₂ nanotubes.

3. The optical lens material of claim 1, wherein the reinforcing agent is made of carbon nanotubes incorporated with ZnO particles, the ZnO particles are adsorbed on the wall of the carbon nanotubes.

4. The optical lens material of claim 2, wherein the ZnO-TNTs and the CBC are mixed by a melt blending.

5. The optical lens material of claim 2, wherein the ZnO-TNTs and CBC are reinforced in interfacial shear stress through Van der Waals interaction.

6. The optical lens material of claim 2, wherein a weight percentage of the ZnO-TNTs in the optical lens material is 0.1%-5.6%, a visible light transmittance of the optical lens material is 95%-96%.

7. The optical lens material of claim 6, wherein a weight percentage of the ZnO-TNTs is 0.81%, a weight percentage of the CBC is 99.19%, the optical lens material has a visible light transmittance of 92%.

8. The optical lens material of claim 6, wherein a weight percentage of the ZnO-TNTs is 1.53%, a weight percentage of the CBC is 98.47%, a visible light transmittance of the optical lens material is 95%.

9. The optical lens material of claim 6, wherein a weight percentage of the ZnO-TNTs is 2.8%, a weight percentage of the CBC is 97.2%, a visible light transmittance of the optical lens material is 95.2%.

10. The optical lens material of claim 6, wherein a weight percentage of the ZnO-TNTs is 5.6%, a weight percentage of the CBC is 97.2%, a visible light transmittance of the optical lens material is 94%.

11. An optical lens made of an optical lens material, the optical lens material comprising:
a cyclic block copolymers; and
a reinforcing agent;
wherein the reinforcing agent is made of nanotubes incorporated with ZnO particles, the ZnO particles are adsorbed on the wall of the nanotubes.
